(19) United States
(12) Patent Application Publication
(10) Pub. No.: US 2015/0362104 A1
(43) Pub. Date: Dec. 17, 2015

(54) PIPING COMPONENT AND PIPE

(71) Applicant: KABUSHIKI KAISHA TOSHIBA, Tokyo (JP)

(72) Inventor: Koji TAKAHASHI, Yokkaichi Mie (JP)

(73) Assignee: KABUSHIKI KAISHA TOSHIBA, Tokyo (JP)

(21) Appl. No.: 14/481,777

(22) Filed: Sep. 9, 2014

(30) Foreign Application Priority Data
Jun. 13, 2014 (JP) 2014-122662

(51) Int. Cl. F16L 21/00; F16L 21/08; F16L 25/00

(52) U.S. Cl. CPC F16L 21/002; F16L 25/0018; F16L 21/08; F16L 2201/40

(57) ABSTRACT

A piping component according to an embodiment comprises a connecting tube. The connecting tube connects a first piping unit and a second piping unit to be attachable to or detachable from each other, thereby forming one pipe. The connecting tube has a first connection surface to be connected to the first piping unit. The first connection surface is inclined relative to a plane orthogonal to central axis directions of the pipe.

### CROSS REFERENCE TO RELATED APPLICATIONS

This application is based upon and claims the benefit of priority from the prior Japanese Patent Application No. 2014-122662, filed on Jun. 13, 2014, the entire contents of which are incorporated herein by reference.

### FIELD

Embodiments described herein relate generally to a piping component and a pipe.

### BACKGROUND

Conventionally, one pipe is often formed by connecting a plurality of piping units. For example, there are cases where a center ring and an O-ring are sandwiched by connection surfaces of two piping units and then these piping units are clamped with a clamp to be connected.

This type of pipe is used to detoxify gas generated in a semiconductor manufacturing device in a manufacturing process of a semiconductor in some cases. In these cases, the pipe is joined between the semiconductor manufacturing device and a pump and between the pump and a detoxifying device to form a flow of gas from the semiconductor manufacturing device to the detoxifying device. The gas introduced through the pipe into the detoxifying device is detoxified by the detoxifying device.

In such a pipe configured by connecting a plurality of piping units, maintenance can be performed for each of the piping units by removing arbitrary one of the piping units.

However, when a piping unit is to be removed from the conventional pipe, piping units located before and after the piping unit to be removed need to be pushed outward in central axis directions of the pipe. Accordingly, load is applied onto connection points of piping units other than the piping unit to be removed and thus the connection points may become loose. Furthermore, because other piping units before and after the piping unit to be removed need to be pushed outward when the piping unit is removed, maintainability and work efficiency are low.

### BRIEF DESCRIPTION OF THE DRAWINGS

FIG. 1 is a front view showing an example of a configuration of a pipe 1 according to a first embodiment;

FIG. 2 is an exploded front view showing the example of the configuration of the pipe 1 according to the first embodiment;

FIG. 3 is an exploded perspective view showing the example of the configuration of the pipe 1 according to the first embodiment;

FIGS. 4A and 4B are schematic diagrams showing an example of an attachment/detachment operation of the pipe 1 according to the first embodiment;

FIG. 5 is a front view showing an example of a configuration of the pipe 1 according to the second embodiment; and

FIG. 6 is a front view showing an example of a configuration of the pipe 1 according to the third embodiment.

### DETAILED DESCRIPTION

A piping component according to an embodiment comprises a connecting tube. The connecting tube connects a first piping unit and a second piping unit to be attachable to or detachable from each other, thereby forming one pipe. The connecting tube has a first connection surface to be connected to the first piping unit. The first connection surface is inclined relative to a plane orthogonal to central axis directions of the pipe.

Embodiments of the present invention will now be explained with reference to the accompanying drawings. The present invention is not limited to the embodiments.

### First Embodiment

### Configuration Example

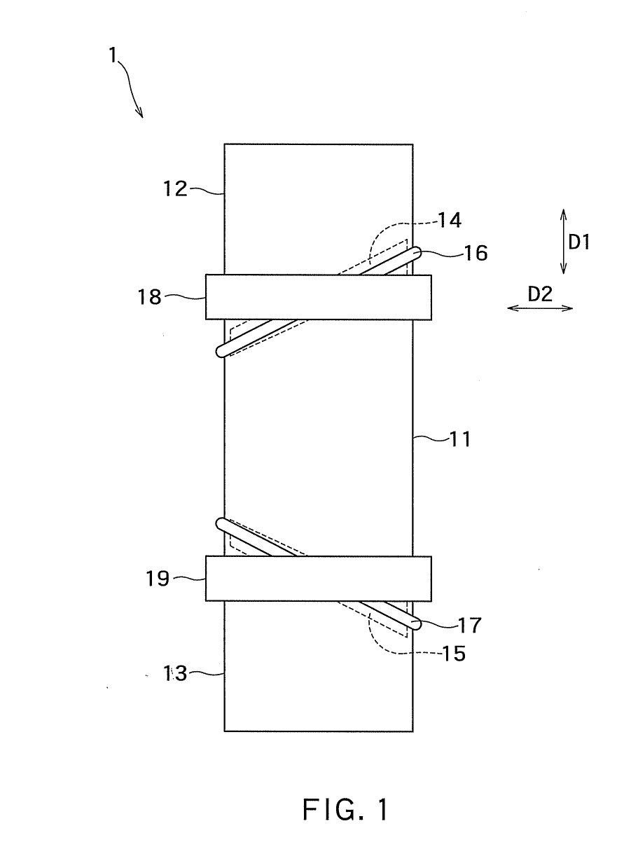

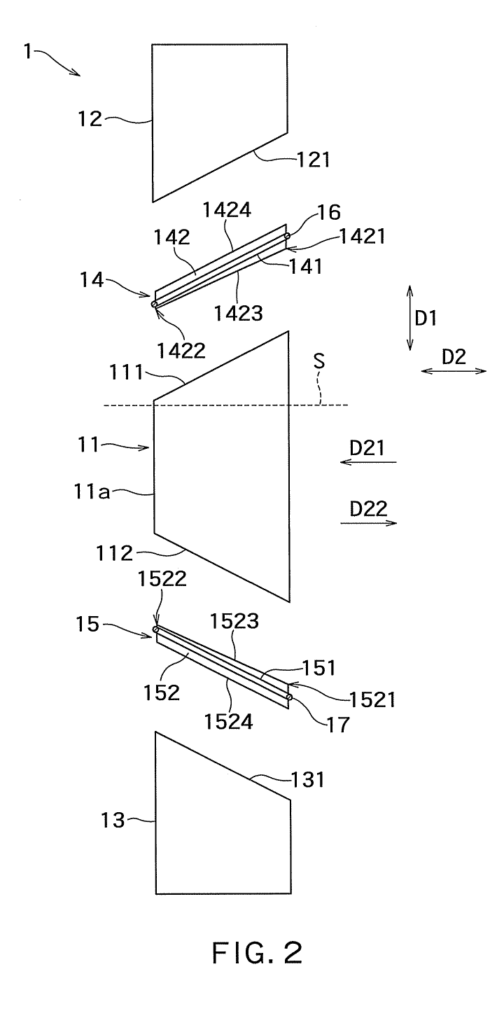

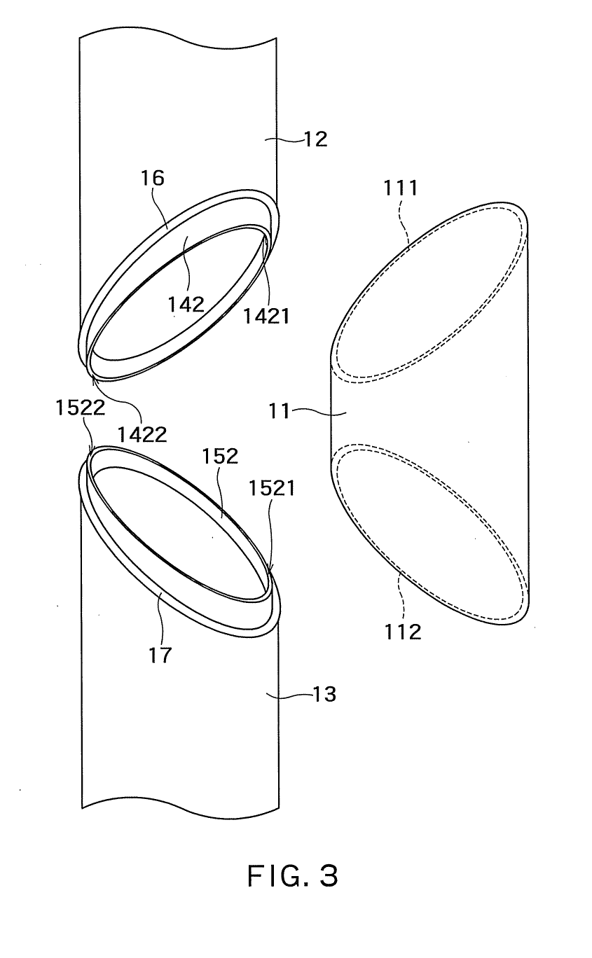

FIG. 1 is a front view showing an example of a configuration of a pipe 1 according to a first embodiment. FIG. 2 is an exploded front view showing the example of the configuration of the pipe 1 according to the first embodiment. FIG. 3 is an exploded perspective view showing the example of the configuration of the pipe 1 according to the first embodiment.

As shown in FIG. 1, the pipe 1 includes a connecting tube 11, a first piping unit 12, a second piping unit 13, a first center ring 14, a second center ring 15, a first O-ring 16, a second O-ring 17, a first clamp 18, and a second clamp 19. These constituent units 11 to 19 are all piping components that form the pipe 1.

### (Connecting Tube 11)

As shown in FIGS. 2 and 3, the connecting tube 11 is formed in a substantially cylindrical shape. The connecting tube 11 has a first connection surface 111 to be connected to the first piping unit 12 and a second connection surface 112 to be connected to the second piping unit 13. The first connection surface 111 is one end face of the connecting tube 11 in central axis directions (hereinafter, also simply as “axis directions”) D1 of the pipe 1. The second connection surface 112 is the other end face of the connecting tube 11 in the axis directions D1. The first connection surface 111 and the second connection surfaces 112 are inclined relative to a plane (hereinafter, also “orthogonal plane”) S orthogonal to the axis directions D1.

Specifically, the first connection surface 111 is inclined in one of the axis directions D1, that is, toward the second piping unit 13 (downward in FIG. 2) from one end (the right end in FIG. 2) in radial directions D2 of the pipe 1 (hereinafter, also simply “radial directions D2”) to the other end (the left end in FIG. 2) thereof. The second connection surface 112 is inclined in the other of the axis directions D1, that is, toward the first piping unit 12 (upward in FIG. 2) from one end (the right end in FIG. 2) in the radial directions D2 to the other end (the left end in FIG. 2) thereof. An angle of inclination of the second connection surface 112 is opposite in the inclination direction to an angle of inclination of the first connection surface 111 and has the same value in the absolute value as that of the first connection surface 111. Therefore, when the connecting tube 11 is inverted upside down, the first connection surface 111 can be used as a connection surface to the second piping unit 13 and the second connection surface 112 can be used as a connection surface to the first piping unit 12.

The connecting tube 11 described above detachably connects between the first piping unit 12 and the second piping unit 13, thereby forming one pipe 1. The angles of inclination of the first connection surface 111 and the second connection surface 112 relative to the orthogonal plane S are not particularly limited and can be, for example, not less than 30 degrees and not more than 60 degrees. The diameter of the connecting tube 11 is not particularly limited as long as it is equal to that of the first piping unit 12 and the second piping unit 13. Furthermore, the dimension in the axis directions D1 of a portion shortest in the axis directions D1 (hereinafter, “shortest portion”) 11a in the connecting tube 11 is not particularly limited. For example, the diameter of the connecting tube 11 can be equal to or larger than 40 millimeters and the dimension in the axis directions D1 of the shortest portion 11a can be equal to or larger than 50 millimeters.

### (First Piping Unit 12)

As shown in FIG. 2, the first piping unit 12 has a third connection surface 121 to be connected to the connecting tube 11. The first piping unit 12 is connected on the third connection surface 121 to the first connection surface 111 of the connecting tube 11. The third connection surface 121 is also inclined relative to the orthogonal plane S. Specifically, the third connection surface 121 is inclined toward the connecting tube 11 (downward in FIG. 2) from one end (the right end in FIG. 2) in the radial directions D2 to the other end (the left end in FIG. 2). The third connection surface 121 can be parallel or not parallel to the first connection surface 111. Also when the third connection surface 121 is not parallel to the first connection surface 111, the first O-ring 16 sandwiched by the connection surfaces 121 and 111 can absorb a difference in angles of inclination of the connection surfaces 121 and 111 to airtightly connect the connecting tube 11 and the first piping unit 12 to each other.

### (Second Piping Unit 13)

As shown in FIG. 2, the second piping unit 13 has a fourth connection surface 131 to be connected to the connecting tube 11. The second piping unit 13 is connected on the fourth connection surface 131 to the second connection surface 112 of the connecting tube 11. The fourth connection surface 131 is also inclined relative to the orthogonal plane S. Specifically, the fourth connection surface 131 is inclined toward the connecting tube 11 (upward in FIG. 2) from one end (the right end in FIG. 2) in the radial directions D2 to the other end (the left end in FIG. 2). The fourth connection surface 131 also can be parallel to or not parallel to the second connection surface 112. Also when the fourth connection surface 131 is not parallel to the second connection surface 112, the second O-ring 17 sandwiched by the connection surfaces 131 and 112 can absorb a difference in angles of inclination of the connection surfaces 131 and 112 to airtightly connect the connecting tube 11 and the second piping unit 13 to each other.

### (First Center Ring 14)

As shown in FIG. 2, the first center ring 14 is located between the first connection surface 111 and the first piping unit 12. The first center ring 14 is attachable to or detachable from the connecting tube 11 and the first piping unit 12. The first center ring 14 has a first groove 141 in an annular shape to which the first O-ring 16 is attached and a first circumferential wall 142 in a tubular shape.

The first groove 141 is formed on an outer circumferential surface of the first circumferential wall 142. The first groove 141 is inclined relative to the orthogonal plane S as viewed in a direction orthogonal to the axis directions D1 (a side surface direction). More specifically, the first groove 141 is inclined toward the connecting tube 11 (downward in FIG. 2) from one end (the right end in FIG. 2) in the radial directions D2 to the other end (the left end in FIG. 2). In this case, the axis directions D1 are an example of central axis directions of the first center ring 14 and the orthogonal plane S is an example of a plane orthogonal to the central axis directions of the first center ring 14.

The first circumferential wall 142 extends in a direction from the first groove 141 to the connecting tube 11 and extends also in a direction from the first groove 141 to the first piping unit 12. A portion of the first circumferential wall 142 extending in the direction from the first groove 141 to the connecting tube 11 comes in contact with an inner circumferential surface of the connecting tube 11 to be fitted in the connecting tube 11. A portion of the first circumferential wall 142 extending in the direction from the first groove 141 to the first piping unit 12 comes in contact with an inner circumferential surface of the first piping unit 12 to be fitted in the first piping unit 12.

The first circumferential wall 142 has a largest portion 1421 in which an amount of extension from the first groove 141 to the connecting tube 11 (hereinafter, also “first extension amount”) is the largest. The first circumferential wall 142 has a smallest portion 1422 in which the first extension amount is the smallest. On the other hand, an amount of extension from the first groove 141 to the first piping unit 12 (hereinafter, also “second extension amount”) is substantially uniform. The connecting tube 11 is attached to the first center ring 14 in a direction D21 from the largest portion 1421 to the smallest portion 1422. The connecting tube 11 is detached from the first center ring 14 in a direction D22 from the smallest portion 1422 to the largest portion 1421. The first extension amounts of the largest portion 1421 and the smallest portion 1422 are not particularly limited and, for example, the first extension amount of the largest portion 1421 can be equal to or smaller than 3 millimeters while the first extension amount of the smallest portion 1422 can be equal to or smaller than 1 millimeter. The second extension amount is not particularly limited either and can be, for example, equal to or smaller than 3 millimeters.

An end face (hereinafter, also “first end face”) 1423 of the first circumferential wall 142 on the side of the connecting tube 11 is inclined relative to the orthogonal plane S. The first end face 1423 is inclined at a smaller angle than the first groove 141. This difference in angles of inclination between the first end face 1423 and the first groove 141 forms the largest portion 1421 and the smallest portion 1422. On the other hand, an end face (hereinafter, also “second end face”) 1424 of the first circumferential wall 142 on the side of the first piping unit 12 is inclined relative to the orthogonal plane S at a larger angle than the first end face 1423. The second end face 1424 can be parallel to the third connection surface 121 of the first piping unit 12.

### (First O-Ring 16)

The first O-ring 16 shown in a cross-section in FIG. 2 is attached to the first center ring 14 by being fitted in the first groove 141. The first O-ring 16 is attachable to or detachable from the first center ring 14. The first O-ring 16 is formed in an ellipsoidally annular shape and has a shape suitable for attachment to the first center ring 14 from the beginning of manufacturing. The first O-ring 16 is sandwiched by the first connection surface 111 of the connecting tube 11 and the third connection surface 121 of the first piping unit 12 in a state being attached to the first center ring 14. Accordingly, the connecting tube 11 and the first piping unit 12 can be airtightly connected to each other.

### (Second Center Ring 15, Second O-Ring 17)

As shown in FIG. 2, the second center ring 15 is located between the second connection surface 112 and the second piping unit 13. The second center ring 15 is attachable to or detachable from the connecting tube 11 and the second piping unit 13.

The second center ring 15 has the same shape as the first center ring 14. Specifically, the second center ring 15 has a second groove 151 in the same shape as the first groove 141 and a second circumferential wall 152 in the same shape as the first circumferential wall 142. The second O-ring 17 in the same shape as the first O-ring 16 is attached to the second groove 151.

The second circumferential wall 152 has a largest portion 1521 in the same shape as the largest portion 1421 of the first circumferential wall 142. The second circumferential wall 152 also has a smallest portion 1522 in the same shape as the smallest portion 1422 of the first circumferential wall 142. The second circumferential wall 152 further has a first end face 1523 in the same shape as the first end face 1423 of the first circumferential portion 142. Furthermore, the second circumferential wall 152 has a second end face 1524 in the same shape as the second end face 1424 of the first circumferential wall 142. The connecting tube 11 is attached to the second center ring 15 in the direction D21 from the largest portion 1521 to the smallest portion 1522. The connecting tube 11 is detached from the second center ring 15 in the direction D22 from the smallest portion 1522 to the largest portion 1521.

### (First Clamp 18)

As shown in FIG. 1, the first clamp 18 is located on an outer circumferential of a connection point between the connecting tube 11 and the first piping unit 12. The first clamp 18 applies a force pressing the first connection surface 111 (see FIG. 2) in the radial directions D2 onto the connection point between the connecting tube 11 and the first piping unit 12. That is, the first clamp 18 applies a force causing the first connection surface 111 and the third connection surface 121 (see FIG. 2) to press against each other in the radial directions D2 onto the connection point between the connecting tube 11 and the first piping unit 12.

### (Second Clamp 19)

The second clamp 19 is located on an outer circumference of a connection point between the connecting tube 11 and the second pining unit 13. The second clamp 19 applies a force pressing the second connection surface 112 (see FIG. 2) in the radial directions D2 onto the connection point between the connecting tube 11 and the second piping unit 13. That is, the second clamp 19 applies a force causing the second connection surface 112 and the fourth connection surface 131 (see FIG. 2) to press against each other in the radial directions D2 onto the connection point between the connecting tube 11 and the second piping unit 13.

### (Attachment/Detachment Operation)

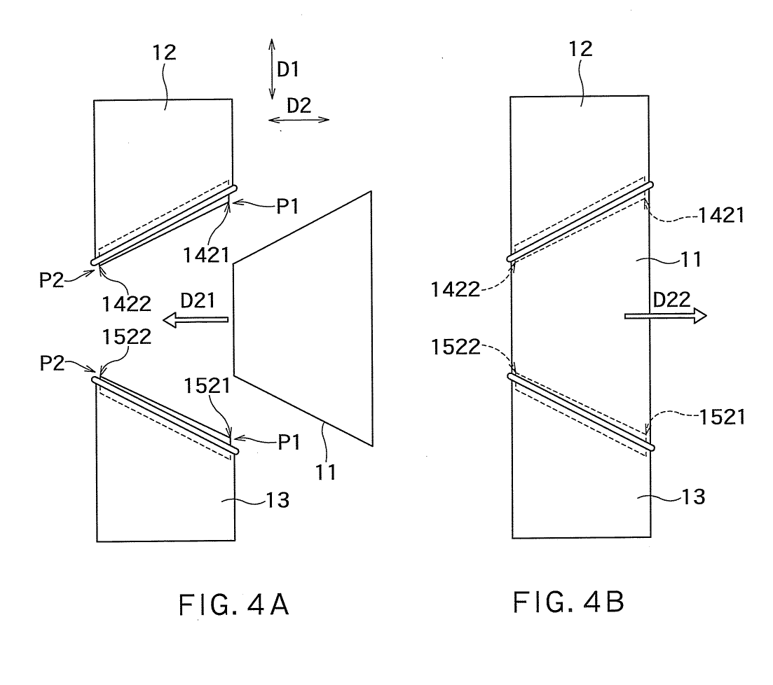

FIGS. 4A and 4B are schematic diagrams showing an example of an attachment/detachment operation of the pipe 1 according to the first embodiment. FIG. 4A is a schematic diagram showing an example of an attachment operation of the connecting tube 11. FIG. 4B is a schematic diagram showing an example of a detachment operation of the connecting tube 11.

As shown in FIG. 4A, when the connecting tube 11 is attached to the first piping unit 12 and the second piping unit 13, the first center ring 14 is first mounted on the first piping unit 12 and the second center ring 15 is mounted on the second piping unit 13.

In this case, a distance between the first piping unit 12 and the second piping unit 13 in the axis directions D1 is the largest on one end (the right end in FIG. 4A) in the radial directions D2 and the smallest on the other end (the left end in FIG. 4A) in the radial directions D2. The largest portion 1421 of the first center ring 14 and the largest portion 1521 of the second center ring 15 extend at positions P1 where the distance between the piping units 12 and 13 in the axis directions D1 is the largest. On the other hand, the smallest portion 1422 of the first center ring 14 and the smallest portion 1522 of the second center ring 15 extend little at positions P2 where the distance between the piping units 12 and 13 in the axis directions D1 is the smallest.

The connecting tube 11 is then inserted between the piping units 12 and 13 in the direction D21 from the largest portions 1421 and 1521 to the smallest portions 1422 and 1522.

At this time, the amounts of extension of the first center ring 14 and the second center ring 15 toward the connecting tube 11 are sufficiently suppressed at the positions P2 because of the smallest portions 1422 and 1522. Therefore, insertion of the connecting tube 11 is hardly interrupted by the first center ring 14 and the second center ring 15 at the positions P2. Therefore, the connecting tube 11 can be smoothly inserted between the first piping unit 12 and the second piping unit 13. On the other hand, the amounts of extension of the first center ring 14 and the second center ring 15 toward the connecting tube 11 are sufficiently ensured at the positions P1 because of the largest portions 1421 and 1521. Therefore, the connecting tube 11 inserted between the first piping unit 12 and the second piping unit 13 can be caused to abut on the first center ring 14 and the second center ring 15 at the positions P1 and be positioned at an appropriate place.

In this way, by inserting the connecting tube 11 in the direction from the largest portions 1421 and 1521 to the smallest portions 1422 and 1522, the connecting tube 11 can be easily attached at a correct position between the first piping unit 12 and the second piping unit 13.

The connection point between the connecting tube 11 and the first piping unit 12 is then clamped with the first clamp 18 in the radial directions D2 as shown in FIG. 1, whereby attachment of the connecting tube 11 to the first piping unit 12 is completed. At that time, the first clamp 18 presses the first connection surface 111 and the third connection surface 121 against each other in the radial directions D2, thereby enabling the connecting tube 11 to be brought into airtight contact with the first piping unit 12.

Furthermore, by clamping the connection point between the connecting tube 11 and the second piping unit 13 with the second clamp 19 in the radial directions D2, attachment of the connecting tube 11 to the second piping unit 13 is completed. At that time, the second clamp 19 presses the second connection surface 112 and the fourth connection surface 131 against each other in the radial directions D2, thereby enabling the connecting tube 11 to be brought into airtight contact with the second piping unit 13.

Meanwhile, when the connecting tube 11 is detached from the first piping unit 12 and the second piping unit 13, the connecting tube 11 is detached in the direction D22 from the smallest portions 1422 and 1522 to the largest portions 1421 and 1521 as shown in FIG. 4B.

At this time, at the positions P2 where the distance between the piping units 12 and 13 in the axis directions D1 is the smallest, the amounts of extension of the first center ring 14 and the second center ring 15 toward the connecting tube 11 are sufficiently suppressed because of the smallest portions 1422 and 1522. Therefore, detachment of the connecting tube 11 is not interrupted by the first center ring 14 or the second center ring 15. In this way, by detaching the connecting tube 11 in the direction D22 from the smallest portions 1422 and 1522 to the largest portions 1421 and 1521, the connecting tube 11 can be appropriately detached in the radial direction.

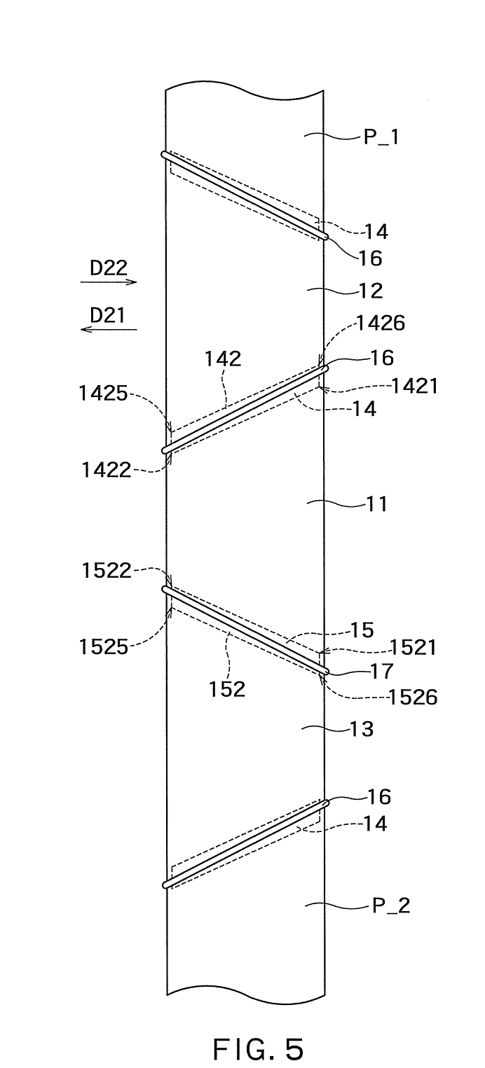

As described above, in the pipe 1 according to the first embodiment, the first connection surface 111 and the second connection surface 112 are inclined relative to the orthogonal plane S. Accordingly, the connecting tube 11 can be attached and detached in the radial directions D2 to and from the first piping unit 12 and the second piping unit 13 without pushing outward the first piping unit 12 and the second piping unit 13. As a result, the labor of pushing outward the first piping unit 12 and the second piping unit 13 in the axis directions D1 can be eliminated at the time of attachment and detachment of the connecting tube 11, which enhances work efficiency and maintainability. Furthermore, it is unnecessary to push the first piping unit 12 and the second piping unit 13 outward and thus, when a part of the pipe 1 is to be removed, application of load onto connection points of other parts in the pipe 1 can be suppressed. Accordingly, loosening at the connection points of other parts in the pipe 1 can be suppressed. For example, when the pipe 1 has a plurality of connection points as shown in FIG. 5, loosening at connection points other than the connection point between the connecting tube 11 and the first piping unit 12 and the connection point between the connecting tube 11 and the second piping unit 13 can be suppressed.

Furthermore, in the first embodiment, the connecting tube 11 has a symmetrical shape with respect to the orthogonal plane S to the axis directions D1 (a vertically symmetrical shape in FIG. 2) and thus, even if positions of the first connection surface 111 and the second connection surface 112 shown in FIG. 2 are inverted, the connecting tube 11 can be appropriately attached. This can eliminate the labor of an operator to confirm a direction of the connecting tube 11 at the time of attachment of the connecting tube 11. Furthermore, the first center ring 14 and the second center ring 15 have the same shape and the first O-ring 16 and the second O-ring 17 have the same shape. Therefore, the same type of center rings can be used for the first center ring 14 and the second center ring 15 and the same type of O-rings can be used for the first O-ring 16 and the second O-ring 17. As a result, at the time of attachment of the first center ring 14, the second center ring 15, the first O-ring 16, and the second O-ring 17, the operator does not need to confirm directions of the piping components 14 to 17. Furthermore, it suffices to manufacture the same center rings and the same O-rings and accordingly the manufacturing cost can be suppressed.

### Second Embodiment

A second embodiment is explained next. In the explanations of the second embodiment, constituent elements corresponding to those of the first embodiment are denoted by like reference numerals and redundant explanations thereof will be omitted.

FIG. 5 is a front view showing an example of a configuration of the pipe 1 according to the second embodiment. As shown in FIG. 5, the first piping unit 12 and the second piping unit 13 have the same shape as that of the connecting tube 11 in the second embodiment. At least one piping unit P_1 and at least one piping unit P_2, which have the same shape as that of the piping components 11 to 13, are connected on the opposite side of the first piping unit 12 to the connecting tube 11 and on the opposite side of the second piping unit 13 to the connecting tube 11, respectively.

The first circumferential wall 142 of the first center ring 14 has a second largest portion 1425 where an amount of extension in a direction to the first piping unit 12 is the largest and a second smallest portion 1426 where an amount of extension in a direction to the first piping unit 12 is the smallest. The second largest portion 1425 is located at a position on an opposite side in axis directions to the smallest portion 1422. The second smallest portion 1426 is located at a position on an opposite side in the axis directions to the largest position 1421.

The second center ring 15 has the same shape as the first center ring 14. That is, the second circumferential wall 152 of the second center ring 15 has a second largest portion 1525 corresponding to the second largest portion 1425 and a second smallest portion 1526 corresponding to the second smallest portion 1426. A center ring 14 in the same shape as the first center ring 14 is located between the first piping unit 12 and the piping unit P_1. Another center ring 14 in the same shape as the first center ring 14 is located between the second piping unit 13 and the piping unit P_2.

The first piping unit 12 is attached to the first center ring 14 in the direction D22 from the second largest portion 1425 to the second smallest portion 1426. The first piping unit 12 is detached from the first center ring 14 in the direction D21 from the second smallest portion 1426 to the second largest portion 1425. Similarly, the second piping unit 13 is attached to the second center ring 15 in the direction D22 from the second largest portion 1525 to the second smallest portion 1526 and is detached therefrom in the direction D21 from the second smallest portion 1526 to the second largest portion 1525.

Other configurations of the second embodiment can be identical to corresponding configurations of the first embodiment.

In the second embodiment, the same type of piping units can be used for all of the connecting tube 11, the first piping unit 12, and the second piping unit 13. This can eliminate the labor of the operator to select components and can enhance work efficiency at the time of assembly of the pipe 1. Other operations of the second embodiment are identical to corresponding operations of the first embodiment. Therefore, the second embodiment can also achieve the effects of the first embodiment.

### Third Embodiment

A third embodiment is explained next. In the explanations of the third embodiment, constituent elements corresponding to those of the second embodiment are denoted by like reference numerals and redundant explanations thereof will be omitted.

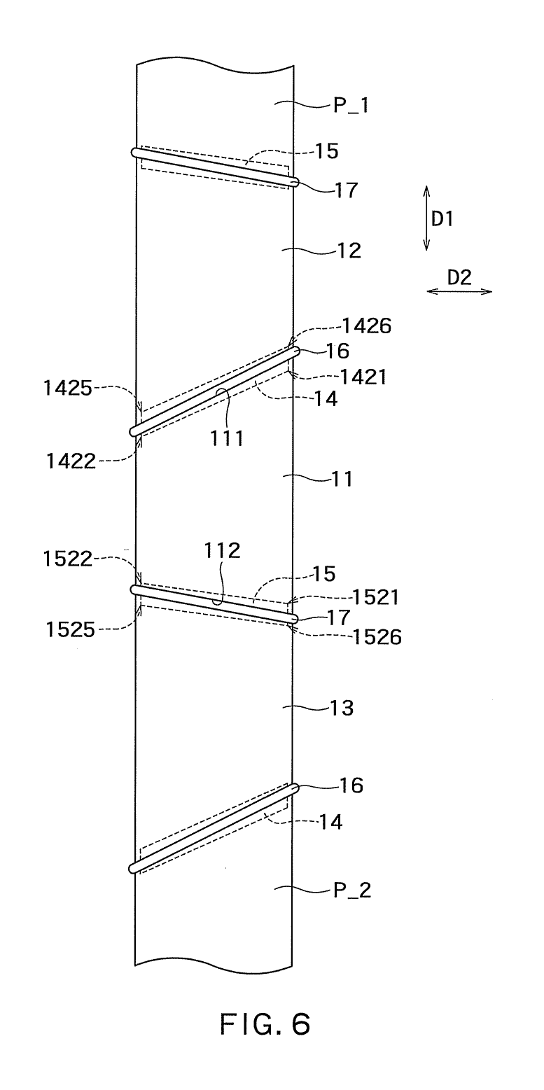

FIG. 6 is a front view showing an example of a configuration of the pipe 1 according to the third embodiment. As shown in FIG. 6, an angle of inclination of the first connection surface 111 and an angle of inclination of the second connection surface 112 are different from each other in the third embodiment. That is, the connecting tube 11 does not have a symmetrical shape with respect to an orthogonal plane to the axis directions D1. Other configurations of the third embodiment can be identical to corresponding configurations of the second embodiment.

Also in the third embodiment, the pipe 1 can be formed with same piping units. Therefore, the first piping unit 12 and the second piping unit 13 have the same shape as that of the connecting tube 11. Accordingly, the same type of piping units can be used for all of the connecting tube 11, the first piping unit 12, and the second piping unit 13.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

1. A piping component comprising a connecting tube connecting a first piping unit and a second piping unit to be attachable to or detachable from each other, thereby forming one pipe, wherein:
the connecting tube has a first connection surface to be connected to the first piping unit, and
the first connection surface is inclined relative to a plane orthogonal to central axis directions of the pipe.

2. The piping component of claim 1, wherein:
the connecting tube has a second connection surface to be connected to the second piping unit, and
the second connection surface is also inclined relative to the plane.

3. The piping component of claim 2, wherein:
the first connection surface is inclined in one of the central axis directions from one end in radial directions of the pipe to the other end thereof, and
the second connection surface is inclined in other of the central axis directions from the one end to the other end.

4. The piping component of claim 1, further comprising:
a first center ring located between the first connection surface and the first piping unit; and
a first O-ring attached to the first center ring and sandwiched by the first connection surface and the first piping unit, wherein:
the first center ring has a first groove in an annular shape to which the first O-ring is attached, and
the first groove as viewed in a direction orthogonal to central axis directions of the first center ring is inclined relative to a plane orthogonal to the central axis directions.

5. The piping component of claim 4, wherein:
the first center ring has a circumferential wall extending in a direction from the first groove to the connecting tube,
the circumferential wall has a largest portion in which an amount of extension toward the connecting tube is largest and a smallest portion in which the amount of extension is smallest, and
the connecting tube is attached to the first center ring in a direction from the largest portion to the smallest portion and is detached therefrom in a direction from the smallest portion to the largest portion.

6. The piping component of claim 3, wherein the second connection surface is inclined in the other of the central axis directions at a same angle as the first connection surface from the one end in the radial directions of the pipe to the other end thereof.

7. The piping component of claim 5, wherein:
the circumferential wall extends also in a direction from the first groove to the first piping unit, and
an amount of extension toward the first piping unit in the circumferential wall is substantially uniform.

8. The piping component of claim 5, wherein an end face of the circumferential wall on a side of the connecting tube is inclined relative to the plane orthogonal to the central axis directions of the first center ring.

9. The piping component of claim 7, wherein an end face of the circumferential wall on a side of the first piping unit is inclined relative to the plane orthogonal to the central axis directions of the first center ring.

10. The piping component of claim 4, wherein the first O-ring is molded in an ellipsoidally annular shape.

11. The piping component of claim 2, further comprising:
a second center ring located between the second connection surface and the second piping unit; and
a second O-ring attached to the second center ring and sandwiched by the second connection surface and the second piping unit, wherein:
the second center ring has a second groove in an annular shape to which the second O-ring is attached, and
the second groove as viewed in a direction orthogonal to central axis directions of the second center ring is inclined relative to a plane orthogonal to the central axis directions.

12. The piping component of claim 11, wherein:
the first connection surface is inclined in one of the central axis directions from one end in radial directions of the pipe to the other end thereof,
the second connection surface is inclined in other of the central axis directions at a same angle as the first connection surface from the one end to the other end,
the second center ring has a same shape as the first center ring, and
the second O-ring has a same shape as the first O-ring.

13. The piping component of claim 2, further comprising:
a first clamp located on an outer circumference of a connection point between the connecting tube and the first piping unit; and
a second clamp located on an outer circumference of a connection point between the connecting tube and the second piping unit, wherein:
the first clamp applies a force pressing the first connection surface in radial directions onto the connection point between the connecting tube and the first piping unit, and
the second clamp applies a force pressing the second connection surface in radial directions onto the connection point between the connecting tube and the second piping unit.

14. A pipe comprising:
a first piping unit;
a second piping unit; and
a connecting tube connecting the first piping unit and the second piping unit to be attachable to or detachable from each other, thereby forming one pipe, wherein:
the connecting tube has a first connection surface to be connected to the first piping unit and a second connection surface to be connected to the second piping unit,
the first connection surface and the second connection surface are inclined relative to a plane orthogonal to central axis directions of the pipe,
the first piping unit has a third connection surface to be connected to the connecting tube,
the second piping unit has a fourth connection surface to be connected to the connecting tube, and
the third connection surface and the fourth connection surface are also inclined relative to the plane orthogonal to the central axis directions of the pipe.

15. The pipe of claim 14, further comprising:
a first center ring located between the first connection surface and the first piping unit;
a first O-ring attached to the first center ring and sandwiched by the first connection surface and the first piping unit;
a second center ring located between the second connection surface and the second piping unit; and
a second O-ring attached to the second center ring and sandwiched by the second connection surface and the second piping unit, wherein:
the first center ring has a first groove in an annular shape to which the first O-ring is attached,
the first groove as viewed in a direction orthogonal to central axis directions of the first center ring is inclined relative to a plane orthogonal to the central axis directions,
the second center ring has a second groove in an annular shape to which the second O-ring is attached,
the second groove as viewed in a direction orthogonal to central axis directions of the second center ring is inclined relative to a plane orthogonal to the central axis directions, and
at least either the first piping unit or the second piping unit has a same shape as that of the connecting tube.

16. The pipe of claim 14, further comprising:
a first clamp located on an outer circumference of a connection point between the connecting tube and the first piping unit; and
a second clamp located on an outer circumference of a connection point between the connecting tube and the second piping unit, wherein:
the first clamp applies a force pressing the first connection surface in radial directions onto the connection point between the connecting tube and the first piping unit, and
the second clamp applies a force pressing the second connection surface in radial directions onto the connection point between the connecting tube and the second piping unit.

17. The piping component of claim 2, further comprising:
a first center ring located between the first connection surface and the first piping unit; and
a first O-ring attached to the first center ring and sandwiched by the first connection surface and the first piping unit, wherein:
the first center ring has a first groove in an annular shape to which the first O-ring is attached, and
the first groove as viewed in a direction orthogonal to central axis directions of the first center ring is inclined relative to a plane orthogonal to the central axis directions.

18. The piping component of claim 3, further comprising:
a first center ring located between the first connection surface and the first piping unit; and
a first O-ring attached to the first center ring and sandwiched by the first connection surface and the first piping unit, wherein:
the first center ring has a first groove in an annular shape to which the first O-ring is attached, and
the first groove as viewed in a direction orthogonal to central axis directions of the first center ring is inclined relative to a plane orthogonal to the central axis directions.
